(19) United States
(12) Patent Application Publication
(10) Pub. No.: US 2017/0289790 A1
(43) Pub. Date: Oct. 5, 2017

(54) REUSING A MOBILE NETWORK OPERATOR PROFILE IN AN EMBEDDED SMART CARD

(71) Applicant: Alcatel-Lucent USA Inc., Murray Hill, NJ (US)

(72) Inventors: Sanjeev K. Singh, New Albany, NJ (US); Thomas Woo, Short Hills, NJ (US)

(21) Appl. No.: 15/085,685

(22) Filed: Mar. 30, 2016

(51) Int. Cl. H04W 8/18

(52) U.S. Cl. CPC H04W 8/183

(57) ABSTRACT

A first smart card in a first wireless communication device receives a first profile that indicates a subscription to provide wireless connectivity to a user. The first profile is a copy of at least a portion of a second profile previously established by the user and stored on a second smart card in a second wireless communication device. The first wireless communication device then establishes a first wireless connection with a network using the subscription indicated by the first profile.

### BACKGROUND

Field of the Disclosure

The present disclosure relates generally to wireless communication systems and, more particularly, to smart cards implemented in wireless communication systems.

Description of the Related Art

Wireless communication systems are becoming more pervasive and are providing Internet connectivity to an ever increasing number and variety of devices, which may include smart phones, tablets, automobiles, watches or other wearable electronics, and the like. Users may therefore use numerous different devices to connect to the Internet for different purposes. For example, a user may use a smart phone for making calls, social networking, or streaming music. The same user may use Internet connectivity in a rental car to find directions to locations in an unfamiliar city and may also use an Internet-connected fitness watch to map the route of a run that is a part of their exercise program. Each device employed by the user is associated with a subscription to a service provided by a mobile network operator (MNO). The user can establish multiple different subscriptions using different smart cards in each device, but this may become expensive as the number of devices used by the user increases.

To receive mobile connectivity on multiple devices via a single subscription, the user may purchase a single smart card (such as a subscriber identity module, SIM, or universal integrated circuit card, UICC) from the MNO and transfer the smart card between the different devices. However, this requires physically removing and reinserting the smart card every time the user wants to use a different device. Swapping the smart card between different devices may always not be possible because some emerging devices such as wearable electronics may not have a form factor that is suitable for implementing a removable smart card. Furthermore, in cases where the smart card can be swapped between devices, the mobile network operator will have to deactivate and reactivate different combinations of the smart card and a device each time the smart card is swapped. Another possibility is to establish a subscription with a primary device (such as a smart phone) and then pair the other devices to the primary device using Bluetooth or Wi-Fi, thereby allowing the other devices to access the Internet via the primary device. However, pairing requires close proximity of the primary and secondary devices.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a wireless communication system according to some embodiments.

FIG. 2 is a diagram of a wireless communication system that supports wireless connectivity using the same subscription indicated by different copies of a profile stored in different smart cards according to some embodiments.

FIG. 3 is a flow diagram of a method for activating a smart phone based on a profile stored in a UICC according to some embodiments.

FIG. 4 is a flow diagram of a method for provisioning a copy of a profile stored by a smart card in a smart phone to another smart card embedded in a UICC according to some embodiments.

FIG. 5 is a flow diagram of a method for terminating a wireless connection formed by a wireless communication device on the basis of a copy of a profile stored by a smart card in a smart phone according to some embodiments.

FIG. 6 is a block diagram of a wireless communication system according to some embodiments.

### DETAILED DESCRIPTION

Multiple devices can be connected to a network, such as the Internet, on the basis of a single user subscription by establishing a trusted relationship between an MNO subscription manager and a primary device that implements a smart card that is programmed to include a profile of the user. The MNO subscription manager generates a copy of the profile in response to a request received from the primary device. The MNO subscription manager may then download the copy of the profile to another smart card implemented in another device in response to a request received from the other device or the primary device. The MNO subscription manager may authenticate the user before providing the copy of the profile. The other device may then establish network connectivity on the basis of the same subscription that is used by the primary device. The smart cards may be subscriber identity modules (SIMs) or universal integrated circuit cards (UICCs). Some embodiments of the profile include information indicating a phone number associated with the user, a network identifier (such as an international mobile subscriber identity, IMSI) that identifies the smart card to the network, a subscriber identifier such as an MSISDN that identifies a subscription to the network (which may be the same as the phone number), and the like. The MNO subscription manager may form the downloaded profiles by duplicating information in the user's original profile or the MNO subscription manager may generate new information for the downloaded profile. The profile may remain installed on the smart card indefinitely (e.g., until the profile is manually uninstalled by the user) or the smart card may be programmed to uninstall the profile in response to expiration of a timer or the occurrence of some other event such as the user leaving an Internet-connected rental car.

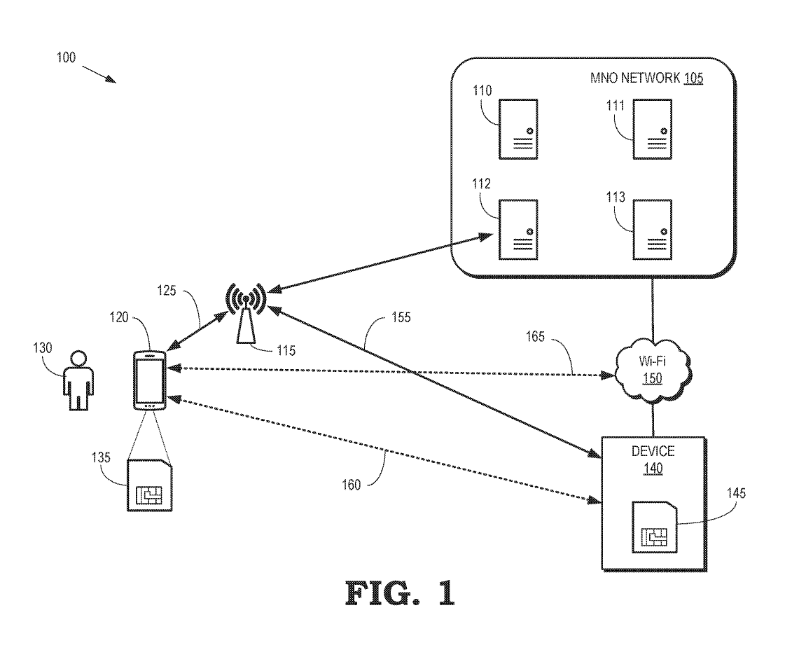

FIG. 1 is a diagram of a wireless communication system 100 according to some embodiments. The wireless communication system 100 includes a network 105 of servers 110, 111, 112, 113 (collectively referred to herein as “the servers 110-113”) that is owned or operated by a mobile network operator (MNO). Although a single MNO network 105 is shown in FIG. 1, some embodiments of the wireless communication system 100 include one or more additional networks that may be owned or operated by other mobile network operators. The network 105 includes a fulfillment server 110 that is used to configure profiles for smart cards such as subscriber identification module (SIM) cards and universal integrated circuit cards (UICCs). The fulfillment server 110 may provide this information to the other servers 111-113. The network also includes a server 111 that supports a home location register (HLR) or a home subscriber server (HSS), which is a database that contains details for each subscriber that is authorized to use the network 105. Some embodiments of the HLR/HSS server 111 store copies of the smart card profiles provided by the fulfillment server 110 and corresponding user profiles, as discussed herein. A SIM over-the-air (OTA) server 112 is used to activate smart cards and manage OTA communication with the wireless communication devices. A subscription manager server 113 stores profiles that indicate subscriptions for receiving wireless connectivity from the network 105. The subscription manager server 113 may also generate copies of the profiles and provide copies of these profiles to other wireless communication devices, as discussed herein.

The wireless communication system 100 includes one or more base stations 115. As used herein, the term “base station” refers to devices that provide wireless connectivity and network access to other wireless communication devices over an air interface. The term “base station” may therefore encompass other terms such as eNodeBs, base station routers, access points, macrocells, microcells, picocells, femtocells, and the like. The base station 115 provides one or more user equipment 120 with wireless connectivity over an air interface 125 so that the user equipment 120 can access the network 105, as well as other external networks such as the Internet. The user equipment 120 accesses the network 105 via the base station 115 according to a subscription established or negotiated between a user 130 and the mobile network operator. The subscription may establish usage charges for voice communication, data transfer, and the like. The subscription may also define other characteristics of communication between the user 130 and the network 105, such as a quality-of-service for voice communication, priorities for data transfer, time-of-day pricing for voice or data usage, and the like.

A smart card 135 is used to store a profile that includes information identifying the user 130 and their corresponding subscription. Some embodiments of the smart card 135 are provided by a vendor, which manufactures and personalizes the smart card 135 for the mobile network operator. The profile identifying the user 130 and the subscription is generated in response to the user 130 negotiating the subscription with the mobile network operator. For example, the profile may be generated by the fulfillment server 110 as part of a sign-up process for the user 130 and then the profile may be provisioned to the HLR/HSS server 111, the SIM OTA server 111, and the subscription manager server 112. The user 130 may insert the smart card 135 into the user equipment 115 and power up the user equipment 115 to initiate activation of the user equipment 115 and the corresponding subscription indicated by the profile stored in the smart card 135. The user equipment 115 communicates with the SIM OTA 111 to perform the activation process, after which the user equipment 115 is able to establish wireless connectivity to the network 105.

The user 130 also owns or has access to other wireless communication devices such as the device 140. Examples of other wireless communication devices include other smart phones, tablets, media streaming devices, wearable electronics such as an Internet-connected fitness watch, network-enabled automobiles such as rental cars, and the like. The device 140 includes an embedded smart card 145. Some embodiments of the device 140 are connected to the network 105 by an interface such as a Wi-Fi connection 150.

The user 130 can enable the device 140 for wireless connectivity using the same subscription as the subscription indicated by the profile stored on the smart card 135 by transmitting a request to the subscription manager server 113 to generate a copy of the profile that indicates the subscription. For example, the user 130 can provide input to the user equipment 120, which may then transmit the request to the subscription manager server 113 via the base station 115. For another example, the user 130 may convey the request to the subscription manager server 113 using other interfaces such as a browser implemented on another computer. The subscription manager server 113 may authenticate the user 130 to verify that the user 130 is authorized to request copies of the profile, e.g. using a username and password that were previously established.

In response to receiving an authenticated request from the user 130, the subscription manager server 113 may generate a copy of the profile stored in the smart card 135. For example, the subscription manager server 113 may access identifiers and credentials (such as security keys) stored in the HLR/HSS server 111 and use this information to duplicate the profile that is stored in the smart card 135 for the user 130. For another example, the subscription manager server 113 may generate some information (such as security keys) and append this information to the copy of profile. Thus, the “copy” of the profile may include identical information to the profile stored in the smart card 135 or it may combine a subset of the information stored in the smart card 135 with freshly generated information. In either case, the copy of the profile indicates the same subscription as the original profile stored in the smart card 135.

The user 130 can request that the subscription manager server 113 provide the copy of the profile to the smart card 145. For example, the user 130 may provide input to the device 140 that is used to generate a request to download the copy of the profile to the smart card 145. The device 140 may provide the request to the subscription manager server 113, which may download the copy of the profile to the smart card 145 in response to the request. Some embodiments of the subscription manager server 113 may authenticate the request to verify that the user 130 is authorized to request download of the copy of the profile, e.g. using a username and password that were previously established. The smart card 145 stores the copy of the profile so that the device 140 is able to use the copy of the profile to receive wireless connectivity based on the same subscription as the subscription indicated by the profile stored in the smart card 135. For example, voice or data usage charges incurred by the device 140 may be billed to the same subscription as voice or data usage charges incurred by the user equipment 120.

Network connectivity may be provided to the device 140 via the user equipment 120 or using a direct connection to the base station 115. For example, the device 140 may establish a wireless connection over an air interface 155 between the device 140 and the base station 115. For another example, the device 140 may be tethered to the user equipment 120 using a wireless connection over an air interface 160, e.g., using a Bluetooth connection. To ensure security and safeguard against fraudulent use of the subscription, some embodiments of the network 105 do not allow concurrent use of the same subscription by different entities to access the network 105. The network 105 may therefore only permit a single one of the wireless communication devices 120, 140 to access the network 105 at a time using the subscription indicated in the smart cards 135, 145. Thus, a wireless connection established between the user equipment 120 and the network 105 may be terminated in response to establishing another wireless connection between the device 140 and the network 105 based on the same subscription.

Wireless connections between the device 140 and the network 105 may be terminated at any time. Termination of the wireless connections may occur in response to expiration of a timer, in response to an event such as the user 130 removing a fitness watch or parking an Internet-enabled rental car, or in response to a request from the user 130 that may be transmitted from the user equipment 120 or the device 140. For example, the user 130 may provide input to the device 140 that terminates the wireless connection with the network 105. For another example, the user 130 may provide input to the user equipment 120 that indicates termination of the wireless connection between the device 140 and the network 105. However, in this case the user equipment 120 may not have an existing wireless connection with the network 105 via the base station 115 because the network 105 may not permit concurrent wireless connections by the devices 120, 140 based on the same subscription. The user equipment 120 may therefore transmit the request to terminate the wireless connection between the device 140 and the network 105 via another connection such as a connection over an air interface 165 to the Wi-Fi connection 150 or the Bluetooth connection 160 to the device 140.

The copy of the profile may be removed from the smart card 145 in response to termination of the wireless connection between the device 140 and the network 105. The wireless connection between the user equipment 120 and the network 105 may be reestablished in response to termination of the wireless connection between the device 140 and the network 105. In some embodiments, the copy of the profile may also be removed from the smart card 145 in response to other events such as expiration of a timer, a changing status of the user 130 or the device 140, and the like.

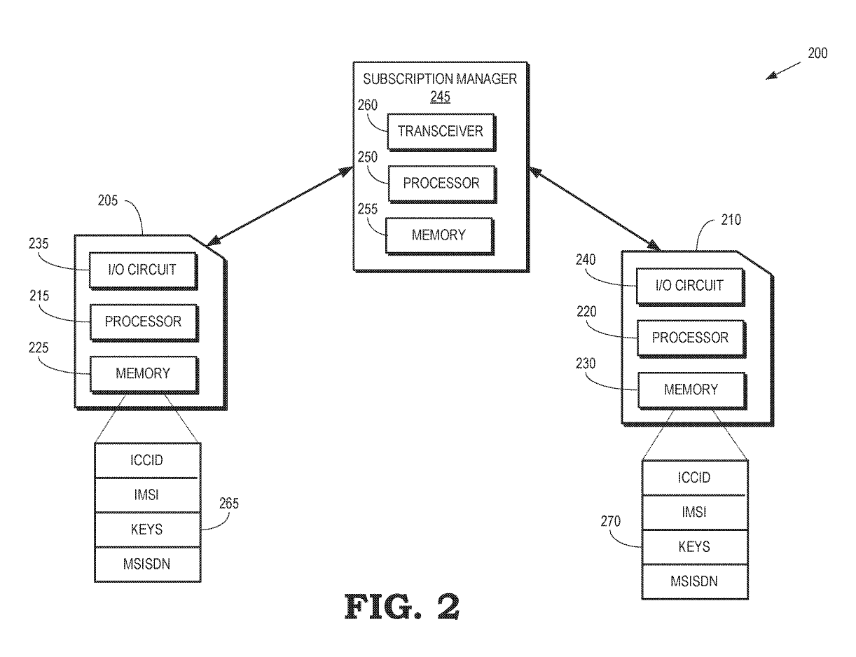

FIG. 2 is a diagram of a wireless communication system 200 that supports wireless connectivity using the same subscription indicated by different copies of a profile stored in different smart cards 205, 210 according to some embodiments. The smart cards 205, 210 may be used to implement some embodiments of the smart cards 135, 145 shown in FIG. 1. The smart cards 205, 210 include corresponding processors 215, 220 and memories 225, 230. The processors 215, 220 are configured to execute instructions such as instructions that may be stored in the memories 225, 230. The instructions may be performed using data stored in the memories 225, 230 and results of the instructions may be stored in the memories 225, 230. The smart cards 205, 210 also include input/output (I/O) circuits 235, 240 that are used for transmitting and receiving signals.

The wireless communication system 200 also includes a subscription manager 245 for generating, storing, and managing profiles that include information identifying user's subscriptions for receiving wireless connectivity and network access, as discussed herein. The subscription manager 245 includes a processor 250 that is configured to execute instructions and memory 255 for storing information such as instructions for execution by the processor 250. The memory 255 may also store data used by or produced by the processor 250. The subscription manager 245 also includes a transceiver 260 that is configured to transmit and receive signals. The subscription manager 245 may be used to implement some embodiments of the subscription manager server 113 shown in FIG. 1.

The subscription manager 245 may generate and provide a profile 265 for storage by the smart card 205. For example, the profile 265 may be generated and provisioned in response to a user (such as the user 120 shown in FIG. 1) signing up for a subscription for wireless connectivity and network access. The profile 265 includes information identifying the subscription that permits the user to access the wireless communication system 100 over an air interface. For example, the profile 265 may include an integrated circuit card identifier (ICCID) that identifies the smart card 205, an international mobile subscriber identity (IMSI) that uniquely identifies the user, credentials such as one or more security keys for encrypting or decrypting information transmitted over the air interface, a mobile station international subscriber directory number (MSISDN) that uniquely identifies the subscription, a phone number that may be used to establish call sessions with the user (which may be the same as the MSISDN in some embodiments), and the like.

In response to a request from the user, the subscription manager 245 may generate a copy 270 of the profile 265. As discussed herein, the copy 270 may include exact copies of some of the information stored in the profile 265 such as the ICCID of the smart card 205, the IMSI of the user, the MSISDN of the user, and one or more security keys used to encrypt or decrypt information transmitted over the air interface. However, some embodiments of the copy 270 may combine exact copies of information (such as the MSISDN or a phone number) in the profile 265 with newly generated information such as fresh security keys that are negotiated with the wireless communication device that includes the smart card 210. The copy of the profile is stored in the memory 220. The stored copy 270 of the profile 265 may be used to establish wireless connectivity on the basis of the same subscription as the subscription indicated by the profile 265.

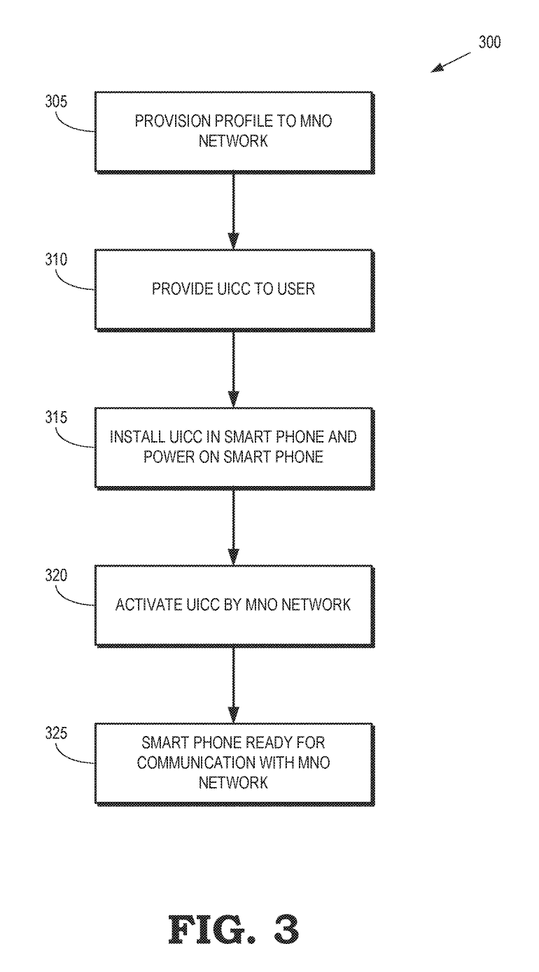

FIG. 3 is a flow diagram of a method 300 for activating a smart phone based on a profile stored in a UICC according to some embodiments. The method 300 may be implemented in some embodiments of the wireless communication system 100 shown in FIG. 1. At block 305, a profile is provisioned to an MNO network such as the network 105 shown in FIG. 1. The profile may be provisioned by MNO fulfillment services following fabrication of the UICC and then configured so that the profile includes information indicating a subscription for wireless connectivity and network access. The subscription may be associated with a user, as indicated by a MSISDN. At block 310, the UICC is provided to the user. At block 315, the user installs the UICC in the smart phone and powers up the smart phone. In response to powering up the smart phone, the UICC is activated by the MNO network at block 320. At block 325, the smart phone is ready for communication with the MNO network on the basis of the subscription indicated in the profile stored in the UICC. The smartphone may therefore establish a wireless connection based on the subscription.

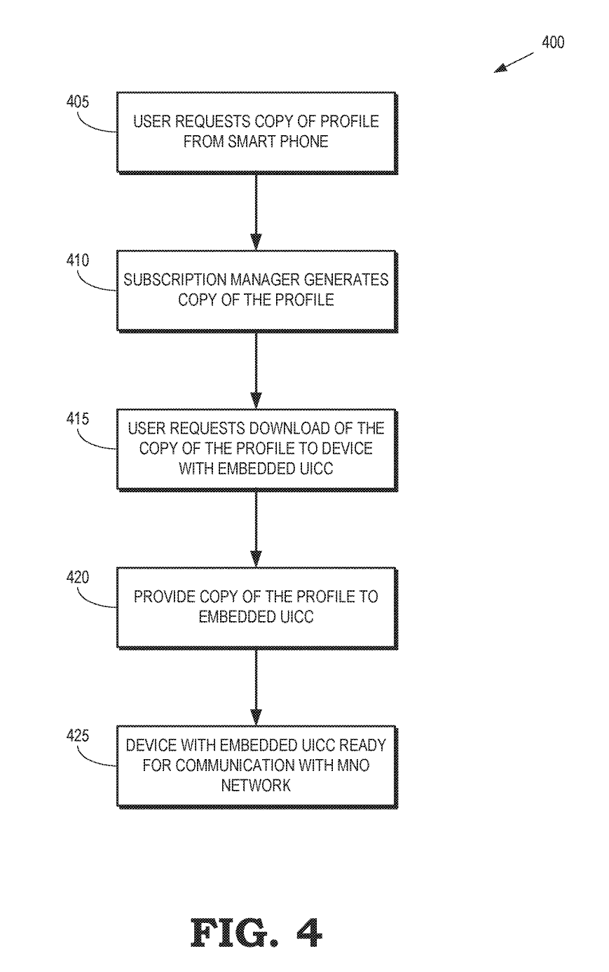

FIG. 4 is a flow diagram of a method 400 for provisioning a copy of a profile stored by a smart card in a smart phone to another smart card embedded in a UICC according to some embodiments. The method 400 may be implemented in some embodiments of the wireless communication system 100 shown in FIG. 1. In the illustrated embodiment, a user has previously negotiated a subscription for wireless connectivity and network access, which is indicated by a profile that is stored in a smart card in the smart phone associated with the user. For example, the smartphone may have been activated according to some embodiments of the method 300 shown in FIG. 3. Information used to generate the profile may also be stored in an HLR server such as the HLR server 112 shown in FIG. 1.

At block 405, the user requests that a copy of the profile be generated, e.g., by a subscription manager such as the subscription manager server 113 shown in FIG. 1. The request may be transmitted from the smartphone in response to user input. Some embodiments of the subscription manager authenticate the request to verify that the user is authorized to request a copy of the profile. At block 410, the subscription manager generates a copy of the profile. As discussed herein, the copy of the profile may be generated using information stored in the HLR server.

At block 415, the user requests a download of the copy of the profile to the wireless communication device that includes the embedded UICC. The user may request the download of the copy of the profile using the wireless communication device, e.g., by inputting information identifying the user or the subscription to the wireless communication device. The user may also request the download of the copy of the profile from other locations including the smart phone or a computer that is connected to the network. Some embodiments of the subscription manager authenticate the request to verify that the user is authorized to request a download of the copy to the wireless communication device. At block 420, the subscription manager provides a copy of the profile to the wireless communication device for storage in the embedded UICC. At block 425, the wireless communication device with the embedded UICC is ready for communication with the MNO network based on the subscription indicated in the copy of the profile.

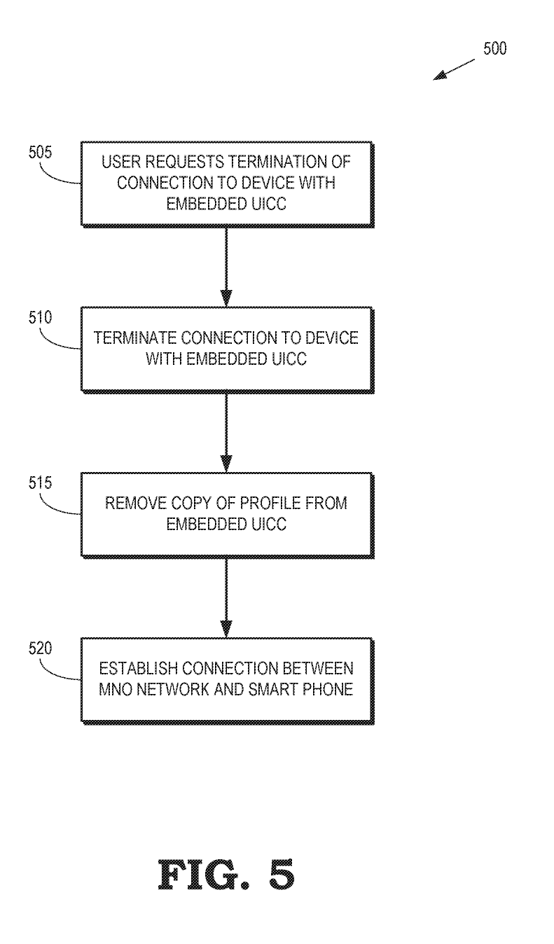

FIG. 5 is a flow diagram of a method 500 for terminating a wireless connection formed by a wireless communication device on the basis of a copy of a profile stored by a smart card in a smart phone according to some embodiments. The method 500 may be implemented in some embodiments of the wireless communication system 100 shown in FIG. 1. In the illustrated embodiment, the wireless communication device has formed a wireless connection with a MNO network (such as the network 105 shown in FIG. 1) on the basis of a subscription indicated by the copy of the profile. For example, the wireless communication device may have established a wireless connection on the basis of the copy of the profile stored in the UICC in the wireless communication device according to embodiments of the method 400 shown in FIG. 4. As discussed herein, some embodiments of the wireless communication system may not support concurrent communication with multiple wireless communication devices using the same subscription. The user may therefore terminate the existing wireless connection in order to establish (or reestablish) a wireless connection between the smart phone and the network on the basis of the subscription.

At block 505, the user requests termination of the wireless connection established on the basis of the profile stored in the UICC in the wireless communication device. Termination may be requested using input to the wireless communication device. Termination may also be requested using input to the smart phone. As discussed herein, the smart phone associated with the user may not be able to establish a wireless connection using the subscription because the subscription is currently in use by the wireless communication device. The smart phone may therefore establish a wireless connection via another interface such as a Wi-Fi interface, a Bluetooth interface, or another interface and use this interface to transmit the request to terminate the wireless connection. Alternatively, the user may use another interface such as a browser on a different computer to request termination of the wireless connection. At block 510, the network terminates the connection to the wireless communication device that includes the embedded UICC. At block 515, the copy of the profile may be removed from the UICC. However, block 515 is optional and may not be performed in all embodiments of the method 500. For example, the copy of the profile may be stored on the UICC so that the wireless communication device can subsequently establish a wireless connection on the basis of the subscription indicated by the profile. At block 520, the smartphone establishes (or reestablishes) a wireless connection with the MNO network.

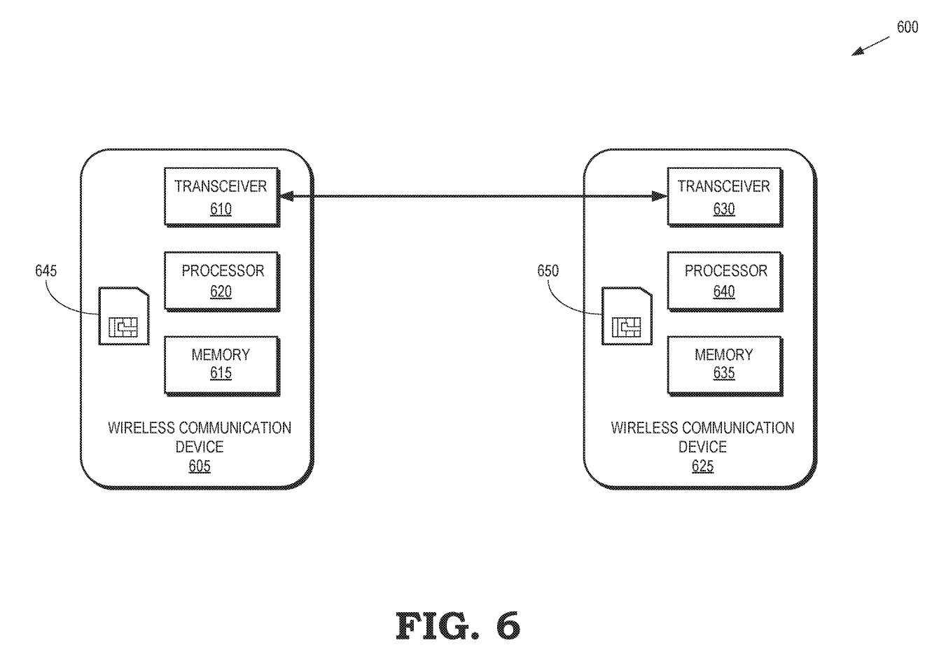

FIG. 6 is a block diagram of a wireless communication system 600 according to some embodiments. The wireless communication system 600 includes a wireless communication device 605 that may be used to implement some embodiments of the smart phone 120 shown in FIG. 1. The wireless communication device 605 includes a transceiver 610 for exchanging uplink and downlink signals over an air interface and a memory 615 for storing information such as processor instructions, data for transmission, received data, and the like. The wireless communication device 605 also includes a processor 620 to process information for transmission, process received information, or perform other operations as discussed herein, e.g., by executing instructions stored in the memory 615.

The wireless communication system 600 also includes another wireless communication device 625 that may be used to implement some embodiments of the device 140 shown in FIG. 1. The wireless communication device 625 includes a transceiver 630 for exchanging uplink and downlink signals over an air interface and a memory 635 for storing information such as processor instructions, data for transmission, received data, and the like. The wireless communication device 625 also includes a processor 640 to process information for transmission, process received information, or perform other operations as discussed herein, e.g., by executing instructions stored in the memory 635.

Smart cards 645, 650 are installed in the wireless communication devices 605, 625, respectively. The smart card 645, 650 may be used to implement some embodiments of the smart card 135, 145 shown in FIG. 1 or the smart cards 205, 210 shown in FIG. 10. The smart card 645 stores a profile including information that indicates a subscription that is used to provide wireless connectivity and network access to a user of the wireless communication device 605. As discussed herein, a copy of the profile may be generated and downloaded to the smart card 650 so that the user can receive wireless connectivity and network access via the other wireless communication device 625. The wireless communication devices 605, 625 may therefore implement some embodiments of the method 300 shown in FIG. 3, the method 400 shown in FIG. 4, or the method 500 shown in FIG. 5.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or is optional combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, at a first smart card in a first wireless communication device, a first profile that indicates a subscription to provide wireless connectivity to a user, wherein the first profile is a copy of at least a portion of a second profile previously established by the user and stored on a second smart card in a second wireless communication device; and
establishing a first wireless connection between the first wireless communication device and a network using the subscription indicated by the first profile.

2. The method of claim 1, wherein the first profile comprises at least one of an integrated circuit card identifier (ICCID) that identifies the second smart card, an international mobile subscriber identity (IMSI) that uniquely identifies the user, a phone number, a mobile station international subscriber directory number (MSISDN) associated with the user, and a security key shared by the second wireless communication device and the network.

3. The method of claim 1, wherein receiving the first profile comprises receiving the first profile from a subscription manager in response to the subscription manager receiving a first request from the second wireless communication device to generate the copy of at least the portion of the second profile.

4. The method of claim 3, further comprising:
providing a second request from the first wireless communication device to download the first profile from the subscription manager, and wherein receiving the first profile comprises receiving the first profile in response to providing the second request.

5. The method of claim 4, wherein receiving the first profile comprises receiving the first profile via a second wireless connection between the first wireless communication device and the second wireless communication device.

6. The method of claim 4, wherein receiving the first profile comprises receiving the first profile via a wireless connection between the first wireless communication device and the network.

7. The method of claim 1, further comprising:
terminating the first wireless connection; and
removing the first profile from the first smart card in response to terminating the first wireless connection.

8. A method comprising:
storing, on a first smart card implemented in a first wireless communication device, a first profile that indicates a subscription to provide wireless connectivity to a user associated with the first smart card; and
providing, from the first wireless communication device, a first request to generate a copy of at least a portion of the first profile for provision to a second smart card implemented in a second wireless communication device.

9. The method of claim 8, wherein the first profile comprises at least one of an integrated circuit card identifier (ICCID) that identifies the first smart card, an international mobile subscriber identity (IMSI) that uniquely identifies the user, a phone number associated with the user, a mobile station international subscriber directory number (MSISDN) associated with the user, and a security key shared by the second wireless communication device and a network.

10. The method of claim 8, further comprising:
activating the first smart card in response to installing the first smart card in the first wireless communication device; and
establishing a first wireless connection between the first wireless communication device and a network based on the subscription indicated in the first profile.

11. The method of claim 10, further comprising:
terminating the first wireless connection in response to the second wireless communication device initiating establishment of a second wireless connection with the network based on the subscription indicated in the copy of at least the portion of the first profile.

12. The method of claim 11, further comprising:
providing a request from the first wireless communication device to terminate the second wireless connection; and
reestablishing the first wireless connection in response to terminating the second wireless connection.

13. A method comprising:
receiving, at a subscription manager for a network, a first request to generate a copy of at least a portion of a first profile stored in a first smart card in a first wireless communication device for provision to a second smart card in a second wireless communication device, wherein the first profile was previously established by a user to indicate a subscription to provide wireless connectivity to the user;
generating the copy of at least the portion of the first profile in response to receiving the first request; and
providing the copy of at least the portion of the first profile to the second smart card.

14. The method of claim 13, wherein the first profile comprises at least one of an integrated circuit card identifier (ICCID) that identifies the first smart card, an international mobile subscriber identity (IMSI) that uniquely identifies the user, a phone number associated with the user, a mobile station international subscriber directory number (MSISDN) associated with the user, and a first security key shared by the first wireless communication device and the network.

15. The method of claim 14, further comprising:
generating a second security key shared by the second wireless communication device and the network; and
appending the second security key to the copy of at least the portion of the first profile.

16. The method of claim 13, wherein receiving the first request to provide at least the portion of the copy of the first profile comprises receiving the first request via a first wireless connection established between the first wireless communication device and the network on the basis of the subscription indicated in the first profile.

17. The method of claim 13, further comprising:
receiving a second request to provide the copy of at least the portion of the first profile to the second smart card;
verifying that the second request was initiated by the user; and
providing at least the portion of the copy of the first profile in response to receiving the second request.

18. A first wireless communication device, comprising:
a first smart card configured to receive a first profile that indicates a subscription to provide wireless connectivity to a user, wherein the first profile is a copy of at least a portion of a second profile previously established by the user and stored on a second smart card in a second wireless communication device; and
a transceiver configured to establish a first wireless connection between the first wireless communication device and a network using the subscription indicated by the first profile.

19. A first wireless communication device comprising:
a smart card configured to store a first profile that indicates a subscription to provide wireless connectivity to a user associated with the first smart card; and
a transceiver configured to provide a first request to generate a copy of at least a portion of the first profile for provision to a second smart card implemented in a second wireless communication device.

20. An apparatus comprising:
a transceiver to receive a first request to generate a copy of at least a portion of a first profile stored in a first smart card in a first wireless communication device for provision to a second smart card in a second wireless communication device, wherein the first profile was previously established by a user to indicate a subscription to provide wireless connectivity to the user;
a processor to generate the copy of at least the portion of the first profile in response to receiving the first request, wherein the transceiver is configured to provide the copy of at least the portion of the first profile to the second smart card.
